(19) United States
(12) Patent Application Publication
(10) Pub. No.: US 2011/0309755 A1
(43) Pub. Date: Dec. 22, 2011

(54) Optoelectronic Device

(76) Inventors: Ralph Wirth, Lappersdorf (DE); Markus Klein, Tegemheim (DE)

(21) Appl. No.: 13/141,079

(22) PCT Filed: Dec. 14, 2009
(86) PCT No.: PCT/EP2009/067108

§ 371 Date: Sep. 7, 2011

(30) Foreign Application Priority Data
Dec. 19, 2008 (DE) 10 2008 064 149.9

(51) Int. Cl. H05B 37/02

(52) U.S. Cl. 315/151

(57) ABSTRACT

An optoelectronic device for emitting mixed light in a first and a different second wavelength range comprises a first or second semiconductor light source (1, 2) with a first or second light-emitting diode (11, 21), which emits light with a first or second characteristic wavelength in the first or second wavelength range and with a first or second intensity on application of a first or second current (41, 42), an optical sensor (3) for converting of a part (110, 510) of the light emitted in each case by the semiconductor light sources (1, 2) into a first or second sensor signal (341, 342), and a feedback controller (4) for feedback control of the first and second current (41, 42) as a function of the first and second sensor signal (341, 342), wherein the characteristic wavelengths and intensities of the light emitted in each case by the first and second semiconductor light sources (1, 2) exhibit a first or different second temperature and/or current and/or ageing dependency (931, 932, 941, 942), the optical sensor (3) exhibits a first or second wavelength-dependent sensitivity in the first or second wavelength range, which sensitivities are adapted to the first and second temperature dependencies (931, 932, 941, 942), and the feedback controller (4) controls the first and second currents (41, 42) in such a way that the first sensor signal (341) exhibits a given ratio to the second sensor signal (342).

The invention relates to an optoelectronic device for emitting a mixed light.

This patent application claims priority from German patent application 102008064149.9, the disclosure content of which is hereby included by reference.

To generate mixed light, i.e. non-monochromatic light and in this case for example white light, when light-emitting diodes (LEDs) are used, use is conventionally made of LEDs which emit in different colors and/or of a plurality of luminescent materials. To generate white light for example, spectral components in the yellow-green and red wavelength ranges may be superposed, these being emitted by different LEDs. However, the challenge here, in addition to fulfilling optical requirements such as for instance the mixing and spatial superposition of light which is emitted by different LED chips, is also to stabilize the color location of the mixed light, for instance the white point, relative to the temperature. This depends for example on various temperature dependencies of the chip technologies involved. In addition, different ageing behaviors and current density behaviors of the LED chips may also lead to modification of the color location and/or the intensity of the mixed light. Open-loop control and feedback control to any desired color location is conventionally only possible using at least three different LEDs, for instance for generating white mixed light by means of one LED emitting yellow-green, one emitting red and in addition one emitting blue.

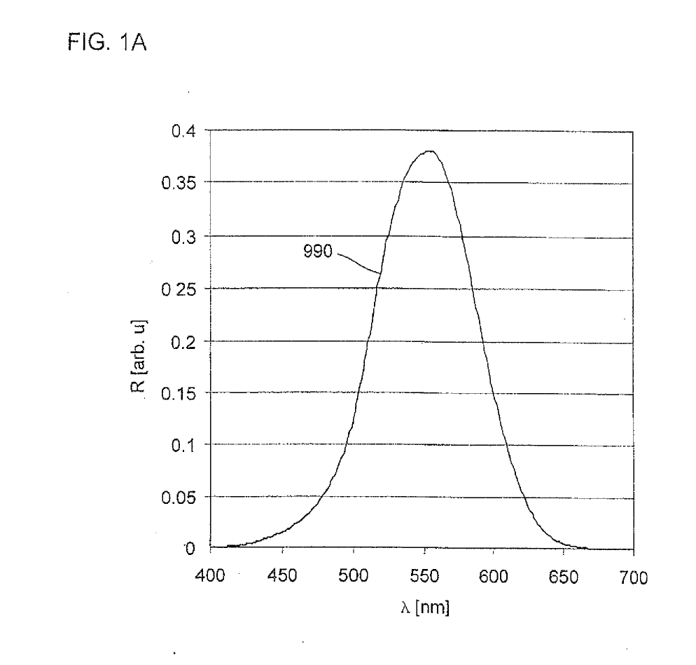

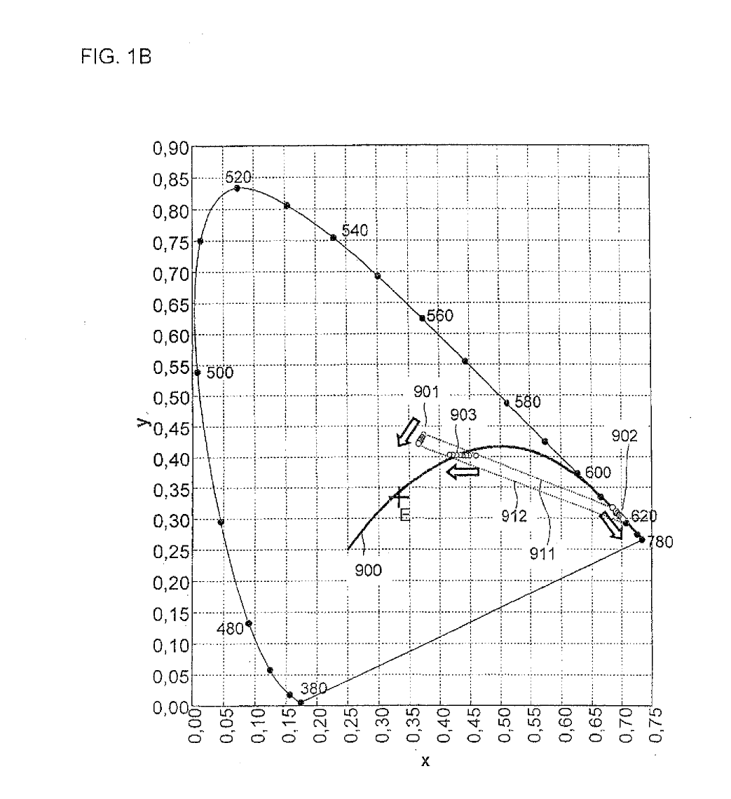

The perception of light by an observer is moreover known to depend on the sensitivity of the human eye as a function of the perceived wavelength. The average spectral sensitivity of the human eye in the case of the average observer with normal color vision is reproduced by the known “V_{λ} curve”, which in FIG. 1A shows the spectral sensitivity R of the human eye in arbitrary units as a function of wavelength λ in a wavelength range of from 400 to 700 nanometers. It is apparent from the V_{λ} curve 990 in FIG. 1A that light stimuli, which are caused by equal strength luminous fluxes with different wavelengths, lead to different brightness appearances. In the case in particular of mixed light sources with LEDs, this effect may have a considerable influence on the color and light appearance of the perceived mixed light, if one or more LEDs for example exhibit a temperature-dependent and/or ageing-related wavelength shift of the emitted light.

At least one object of certain embodiments is to provide an optoelectronic device for emitting light with a first and a second semiconductor light source.

This object is achieved by a subject matter having the features of the independent claim. Advantageous embodiments and further developments of the subject matter are identified in the dependent claims and are disclosed, moreover, in the following description and drawings.

According to at least one embodiment, an optoelectronic device for emitting mixed light with light in at least one first and one second wavelength range comprises in particular
a first semiconductor light source with a first light-emitting diode (LED), which, on application of a first current, emits light with a first characteristic wavelength in the first wavelength range and with a first intensity,
a second semiconductor light source with a second LED, which, on application of a second current, emits light with a second characteristic wavelength in the second wavelength range and with a second intensity, the first and second wavelength ranges exhibiting mutually different, wavelength-dependent intensity distributions,
an optical sensor for converting a part of the light emitted by the first semiconductor light source into a first sensor signal and a part of the light emitted by the second semiconductor light source into a second sensor signal, and
a feedback controller for feedback control of the first and second currents as a function of the first and second sensor signals,
   wherein
the first characteristic wavelength and the first intensity of the light emitted by the first semiconductor light source exhibits a first temperature dependency and/or current dependency and/or ageing and
the second characteristic wavelength and the second intensity of the light emitted by the second semiconductor light source exhibit a second temperature dependency and/or current dependency and/or ageing which is different from the first temperature dependency,
the optical sensor exhibits a first wavelength-dependent sensitivity in the first wavelength range and a second wavelength-dependent sensitivity in the second wavelength range, these being adapted to the first and second temperature dependencies and/or current dependencies and/or ageing, and
the feedback controller controls the first and second currents in such a way that the first sensor signal exhibits a given ratio to the second sensor signal.

Here and hereinafter “light” may in particular mean electromagnetic radiation of one or more wavelengths or wavelength ranges extending from an ultraviolet to infrared spectral range. In particular, light may be visible light and exhibit wavelengths or wavelength ranges from a visible spectral range of between approximately 350 nm and approximately 800 nm. Visible light may here and hereinafter be characterized for example by its color location with x and y color location coordinates according to the CIE-1931 color space chromaticity diagram or CIE standard chromaticity diagram known to a person skilled in the art.

Here and hereinafter light may be denoted white light or light with a white luminance or color appearance which has a color location which corresponds to the color location of a Planckian black body radiator or differs by less than 0.1 and preferably by less than 0.05 in x and/or y color location coordinates from the color location of a Planckian black body radiator. Furthermore, a light appearance denoted here and hereinafter as a white light appearance may be brought about by light which has a “color rendering index” (CRI), known to a person skilled in the art, of greater than or equal to 60, preferably of greater than or equal to 70 and particularly preferably of greater than or equal to 80.

Furthermore, “warm white” may here and hereinafter be used to describe a light appearance which exhibits a color temperature of less than or equal to 5500 K. Furthermore, “cold white” may here and hereinafter be used to describe a light appearance which exhibits a color temperature of greater than 5500 K. The term “color temperature” may here and hereinafter denote the color temperature of a Planckian black body radiator or indeed the “correlated color temperature” (OCT) known to a person skilled in the art in the case of a white light appearance in the above-described sense, which may be distinguished by color location coordinates which differ from the color location coordinates of the Planckian black body radiator.

A first and a second light appearance may here and hereinafter be described as “different” if the first light appearance is brought about by light with a first color location and the second light appearance is brought about by light with a second color location and the first color location may be perceived as different from the second color location. Different luminance impressions may in particular be brought about by mutually different first and second wavelength ranges. Here and hereinafter a first and a second wavelength range may accordingly be described as different if the first and second wavelength ranges exhibit a mutually different spectral intensity or power distribution (“spectral power distribution”), i.e. if for instance the first wavelength range comprises at least one spectral component which is not contained in the second wavelength range. It should here be emphasized that a first and second wavelength range which are different from one another may perfectly well also exhibit identical spectral components. In this case, the first and second wavelength ranges may correspond in one, several or indeed all spectral components with regard to the wavelength thereof, providing at least one of the two wavelength ranges comprises at least one spectral component which is not contained at all or not with the same relative intensity in the other wavelength range, such that the first and second wavelength ranges bring about respective luminance and color appearances with different x and/or different y coordinates in the CIE standard chromaticity diagram. This may in particular mean that the first and second wavelength ranges for example at the same wavelength each comprise spectral components which differ in intensity, for instance by a factor of greater than or equal to 10.

Here and hereinafter a first and second color location or light appearance is described as being perceivable as mutually different if they may be perceived as different from one another by an average human observer. In particular, first and second light appearances with first and second color locations are not different for the purposes of the present application, if the second color location in the McAdams ellipse lies with the first color location as centre point or reference color location or vice versa. The concept of the McAdams ellipses in relation to perceptibilities of color differences is known to a person skilled in the art and is not explained any further here.

The first or second characteristic wavelength may denote the highest intensity wavelength of the first or second wavelength range. Alternatively, the first or second characteristic wavelength may also denote the average wavelength of the first or second wavelength range. Particularly preferably, the first or second characteristic wavelength may also denote the average wavelength, weighted in each case over the individual spectral intensities, of the first or second wavelength range. A change in the first or second characteristic wavelength arises due to a shift in the first or second wavelength range and/or results from a change in the relative intensities of the spectral components of the first or of the second wavelength range. A change in the first or second characteristic wavelength thus also results in a change in the respective color location of the light which is emitted by the first or second semiconductor light source.

In the case of the optoelectronic device described herein, the first sensor signal is dependent on the first intensity and also on the first wavelength range or the first characteristic wavelength. This means in particular that the first sensor signal changes if the first intensity changes and/or if the first wavelength range or the first characteristic wavelength changes, even if the first intensity remains the same. For example, the first sensitivity may increase or decrease as the wavelength increases in the first wavelength range, such that the first sensor signal may accordingly increase or decrease with an increasing first characteristic wavelength, even if the first intensity remains the same. The statements made in connection with the first sensor signal and the first sensitivity accordingly also apply to the second sensor signal and the second sensitivity. In this way, the optical sensor may exhibit wavelength-dependent sensitivity at least in the first and second wavelength ranges, which, as described above with regard to the sensitivity of the human eye to different wavelengths, varies in magnitude. The first and second sensor signals may therefore also take account of changes to the first or second characteristic wavelength, in addition to the change in the first or second intensity. Because the first and second sensitivities are adapted to the first or second wavelength dependencies, the feedback control and open-loop control task of the optoelectronic device, which is intended particularly preferably to lead to a maximally constant luminance and color appearance of the mixed light, may be achieved better than in the case of known feedback controllers. Since the optical sensor thus exhibits the first and second sensitivities, which are adapted to the first and second temperature dependencies and/or current dependencies and/or ageing, the necessary information for correction signals for the first and second currents may be contained by the optical sensor, by means of which information the color location and/or the intensity of the mixed light may for example be feedback controlled.

The predetermined ratio of the first and second sensor signals to one another may be kept constant by the feedback controller. The feedback controller thus makes it possible, for example, for the ratio of the first sensor signal to the second sensor signal to remain constant for example in the event of a change in the ambient and/or operating temperature. This means in particular that, in the event of a change in the first sensor signal and/or in the second sensor signal resulting in the ratio of the first to the second sensor signal also changing, the feedback controller readjusts the first and/or second current and thus the first and/or second intensity such that the change in the ratio of the first sensor signal to the second sensor signal is compensated. The predetermined ratio of the first to the second sensor signal may furthermore also depend on the strength of the first and/or second sensor signal, such that the predetermined ratio may change in a predetermined manner as a function of the first and/or second sensor signal. This may for example make it possible to feedback control the color location of the mixed light with regard to temperature, current applied and/or ageing of the light-emitting diodes together with the first and second sensitivities.

In the case of known feedback controllers, in which the intensity emitted for example by a plurality of LEDs is measured with photodiodes, conventionally only the changes in intensity of the emitted light are taken into account. Conventional feedback controllers thus determine a correction signal, which is solely dependent on the particular measured intensity. In this case, known feedback controllers cannot however compensate any wavelength shifts of the emitted light. As has already been described above, however, it is precisely such wavelength shifts which lead to a change in the perceived color and light appearance, despite the emitted intensity being kept constant by the feedback controller, because of the wavelength-dependent sensitivity of the human eye, since a per se constant luminous flux is perceived as weaker or stronger depending on the wavelength. If for example a plurality of different LEDs are used, which exhibit different wavelength shifts, in the case of LED temperature changes despite feedback control of the respectively emitted intensities of the different LEDs, a considerable change in color location will be perceptible, since precisely none of the wavelength shifts of the various LEDs can be compensated by conventional feedback controllers.

Alternatively, it is known to measure the temperature of the LEDs, a feedback controller comprising one or more temperature sensors. In such a known feedback controller, a table or a database is additionally stored, from which correction values for actuation of the LEDs may be read out as a function of temperature. The correction values may also take account of the respective temperature-dependent wavelength shifts, in addition to the temperature-dependent intensity changes of the individual LEDs.

The feedback controller of the optoelectronic device described herein may comprise passive and/or active analogue and/or digital electronic components, purely by way of example for instance variable resistors, fixed resistors, capacitors, coils, transistors, operational amplifiers, microcontrollers, microprocessors and combinations thereof. In particular, the feedback controller may take the form of a feedback loop or also act directly as a current source for the first and second semiconductor light sources or be integrated into such a current source. The feedback controller may comprise electronic components and circuits which are known from controllers for proportional control, integrating control and/or differential control and which are suitable for feedback and open-loop control of one or more signals, here in particular the first and second sensor signal, relative to predetermined “actual values” or indeed in particular relative to one another. In this case, because of the sensor described herein it is possible in the case of the feedback controller to dispense with components which are required in the above-described known feedback controllers for balancing measured values with stored table values.

An LED of a semiconductor light source, i.e. for instance the first and/or the second LED, may in particular comprise an epitaxial layer sequence, i.e. an epitaxially grown semiconductor layer sequence. In this case, the LED may for example be based on InGaAlN. InGaAlN-based LEDs and semiconductor layer sequences in particular include those in which the epitaxially produced semiconductor layer sequence generally comprises a layer sequence of different individual layers, including at least one individual layer which comprises a material from the III-V compound semiconductor material system InₓAl_{y}Ga_{1-x-y}N with 0≦x≦1, 0≦y≦1 and x+y≦1. Semiconductor layer sequences which comprise at least one active layer based on InGaAlN may for example preferably emit electromagnetic radiation in an ultraviolet to green wavelength range.

Alternatively or in addition, the LED may also be based on InGaAlP, i.e. the LED may comprise different individual layers, of which at least one individual layer comprises a material from the III-V compound semiconductor material system InₓAl_{y}Ga_{1-x-y}P with 0≦x≦1, 0≦y≦1 and x+y≦1. Semiconductor layer sequences or LEDs which comprise at least one active layer based on InGaAlP, may for example preferably emit electromagnetic radiation with one or more spectral components in a green to red wavelength range.

Alternatively or in addition, the semiconductor layer sequence or LED may also comprise other III-V compound semiconductor material systems, such as for instance an AlGaAs-based material, or II-VI compound semiconductor material systems. In particular, an LED comprising an AlGaAs-based material may be suitable for emitting electromagnetic radiation with one or more spectral components in a red to infrared wavelength range. A II-VI compound semiconductor material may comprise at least one element from the second main group or the second subgroup, such as for example Be, Mg, Ca, Sr, Cd, Zn, Sn, and one element from the sixth main group, such as for example O, S, Se, Te. In particular, a II-VI compound semiconductor material comprises a binary, ternary or quaternary compound, which comprises at least one element from the second main group or second subgroup and at least one element from the sixth main group. Such a binary, ternary or quaternary compound may moreover comprise for example one or more dopants and additional constituents. The II-VI compound semiconductor materials for example include: ZnO, ZnMgO, CdS, ZnCdS, MgBeO.

The semiconductor layer sequence of the first and/or second LED may additionally comprise a substrate on which the above-stated III-V or II-VI compound semiconductor materials are deposited. The substrate may in this case comprise a semiconductor material, for example an above-mentioned compound semiconductor material system. In particular, the substrate may comprise sapphire, GaAs, GaP, GaN, InP, SiC, Si and/or Ge or consist of such a material. The semiconductor layer sequence may comprise as active region for example a conventional pn-junction, a double heterostructure, a single quantum well structure (SQW structure) or a multiple quantum well structure (MQW structure). For the purposes of the application, the term “quantum well structure” includes in particular any structure in which charge carriers may undergo quantization of their energy states by inclusion (“confinement”). In particular, the term quantum well structure does not provide any indication of the dimensionality of the quantization. It thus encompasses inter alia quantum troughs, quantum wires and quantum dots and any combination of these structures. The semiconductor layer sequence may, in addition to the active region, comprise further functional layers and functional regions, for instance p- or n-doped charge carrier transport layers, i.e. electrons or hole transport layers, undoped or p- or n-doped confinement, cladding or waveguide layers, barrier layers, planarizing layers, buffer layers, protective layers and/or electrodes and combinations thereof. With regard to the active region or the further functional layers and regions, such structures are known to a person skilled in the art in particular with regard to configuration, function and structure and are therefore not explained in any greater detail at this point.

The first and/or the second LED may also take the form, for example, of thin-film light-emitting diode chips. A thin-film luminescent diode chip is distinguished in particular by one or more of the following characteristic features:
a reflective layer is applied to or formed on a first major surface, facing a support element, of a radiation-generating, epitaxial layer sequence, said reflective layer reflecting at least a part of the electromagnetic radiation generated in the epitaxial semiconductor layer sequence back into it;
the epitaxial layer sequence has a thickness in the range of 20 μm or less, in particular in the range of 10 μm; and/or
the epitaxial layer sequence contains at least one semiconductor layer with at least one face which comprises an intermixing structure, which ideally leads to an approximately ergodic distribution of the light in the epitaxial layer sequence, i.e. it exhibits scattering behavior which is as ergodically stochastic as possible. The epitaxial layer sequence of a thin-film light-emitting diode chip, may be transferred to a carrier substrate in the form of a carrier element by rebonding after growth on a growth substrate.

Furthermore, the first and/or the second semiconductor light source and thus the at least one first and/or second LED may bring about a polychromatic and in particular for example a white light appearance. To this end, the first and/or second LED may comprise a wavelength conversion material, which may be applied in the form of a potting resin or a surface coating on or over the epitaxial layer sequence of the first and/or second LEDs. The wavelength conversion material may be suitable for converting at least a part of the light emitted by an LED, which may lie for instance in an ultraviolet to blue spectral range, into longer wave light, i.e. for instance into light with one or more spectral components in a green and/or a yellow and/or a red wavelength range. By superposing the emitted light with the converted light, a polychromatic, for example white, light appearance may be produced.

The wavelength conversion material may comprise one or more of the following materials: garnets of rare earths and alkaline earth metals, for example YAG:Ce³⁺, nitrides, nitridosilicates, sions, sialons, aluminates, oxides, halophosphates, orthosilicates, sulfides, vanadates, perylenes, coumarin and chlorosilicates. Furthermore the wavelength conversion material may also comprise suitable mixtures and/or combinations thereof. Furthermore, the wavelength conversion material may be embedded in a transparent matrix material, which surrounds or contains the wavelength conversion material. The transparent matrix material may comprise, for example, silicones, epoxys, acrylates, imides, carbonates, olefins or derivatives thereof in the form of monomers, oligomers or polymers and as mixtures, copolymers or compounds therewith. For example, the matrix material may be an epoxy resin, polymethyl methacrylate (PMMA) or a silicone resin.

Furthermore the light generated by the first and/or second semiconductor light source or the first and/or second LED may be determined solely by the selection of the materials of the epitaxial layer sequences without using a wavelength conversion material. For example, the first semiconductor light source may bring about a white light appearance in combination with a wavelength conversion material, while the second semiconductor light source may bring about a colored light appearance. The first semiconductor light source may accordingly for example comprise a first LED based on InGaN, which emits light in a blue wavelength range. Furthermore, the first LED may comprise a wavelength conversion material, which converts a part of the blue primary light into green, yellow or yellow-green secondary light, such that the first wavelength range comprises blue and green, yellow or yellow-green spectral components and brings about a greenish white to cold white color appearance. The second semiconductor light source may comprise a second LED based on InGaAlP, which emits light in a second, red wavelength range. By superposing the light with the first and second wavelength ranges, a warm white luminance impression may be brought about by the mixed light of the optoelectronic device depending on the desired weighting. Alternatively, the second semiconductor light source may also comprise a second LED based on InGaAlP, which generates light in a second, yellow wavelength range, such that the optoelectronic device may emit a mixed light with a cold white light appearance. In such optoelectronic devices a rough preselection of the desired color location may be possible at a given ambient and operating temperature, while fine adjustment or “fine tuning” of the color location is possible using the second semiconductor light source. Alternatively, the first and second semiconductor light sources may be reversed with regard to the previously described wavelength ranges and color appearances.

Furthermore, the first semiconductor light source and/or the second semiconductor light source may in each case comprise a plurality of first or second LEDs, which are in each case of identical construction.

Light-emitting diodes conventionally exhibit negative temperature dependency of the emitted intensity at typical ambient and operating temperatures in the range from −40° C. to 125° C. This means that at a constant electrical current the intensity of the emitted light falls with an increasing ambient and operating temperature. Depending on the construction of and material selected for an LED, the intensity of the light emitted by an LED may fall from 100% at a temperature of 0° C. to an intensity of less than or equal to 90% to greater than or equal to 10% at a temperature of 100° C. Furthermore, depending on the material selected and the embodiment with or without wavelength conversion material, LEDs may exhibit a temperature-dependent shift in the characteristic wavelength of up to +/−5% or more, i.e. of a few nanometers, in a temperature range from 0° C. to 100° C.

The optical sensor for measuring the first and second intensities or a particular part thereof may in particular comprise or be a photodiode and particularly preferably a silicon-based photodiode. Depending on the embodiment, silicon-based photodiodes may be distinguished by a high or at least satisfactory intrinsic sensitivity over the entire visible light wavelength range. For a typical broadband photodiode of silicon, spectral sensitivity rises continuously in the range from approximately 300 to approximately 1000 nanometers and then falls away again, wherein, depending on the embodiment, the maximum sensitivity may also lie in the range from approximately 550 to less than 1000 nanometers.

To adjust the first and second sensitivity of the optical sensor, the latter may comprise a photoactive material with the first and/or second sensitivity as intrinsic intensity or alternatively or additionally an optical filter. The optical filter may exhibit a wavelength-dependent transmittance for adjusting the first and/or second sensitivity. This means that the optical filter may exhibit a transmittance for the light of the first or second semiconductor light source in the first and/or second wavelength range which, in combination with the intrinsic sensitivity of the optical sensor material, corresponds to the desired first or second sensitivity. This may in particular also mean that the combination of the optical filter with its wavelength-dependent transmittance together with the intrinsic sensitivity of the optical sensor material, i.e. for instance the silicon, results in the desired first and second sensitivity. For example the optical filter may comprise an absorptive and/or a thin-film filter or take the form of such a filter, which leads in the first and/or second wavelength range together with the intrinsic spectral sensitivity of the optical sensor to the desired first and/or second sensitivity.

The optical sensor may for example also comprise a first sensor facet and a second sensor facet. The part of the light emitted by the first semiconductor light source in the first wavelength range may in this case be directed at least onto the first sensor facet, while the part of the light emitted by the second semiconductor light source in the second wavelength range may be directed at least onto the second sensor facet. Furthermore, an optical filter may also be arranged on the first and/or the second sensor facet, such that the optical sensor together with the optical filter exhibits the first sensitivity in the first wavelength range in the region of the first sensor facet and the second sensitivity in the second wavelength range in the region of the second sensor facet. In this way, the light of the first semiconductor light source and the light of the second semiconductor light source may also be directed onto the entire active area of the optical sensor, if the optical filter may for example discriminate between the light in the second wavelength range and the overall spectrum with the first and second wavelength range or indeed the light in the first wavelength range in the region of the second sensor facet. The first and second sensor facet may also be isolated electrically and optically from one another, such that the optical sensor may supply the first sensor signal directly as a signal of the first sensor facet and the second sensor signal as a signal of the second sensor facet. Furthermore, the optical sensor may also comprise two separate photodiodes.

Alternatively or in addition, the first and/or the second current may be modulated when the optoelectronic device is in operation. The feedback controller may in this case be suitable for subdividing the signal of the optical sensor into the first and second sensor signals by means of frequency analysis, for example by means of known frequency mixing and filtering methods. To this end, the first and second currents, or indeed just one of the two currents, may be modulated with different frequencies. In particular, the first and/or the second currents may be amplitude-modulated by switching on and off, for example in the form of a square-wave signal.

By virtue of the embodiments described in the form of a spectral analysis by means of the optical filter and/or a frequency analysis, in the case of modulated first and/or second currents, it may be possible for the optical sensor to “distinguish” between the light of the first semiconductor light source and the light of the second semiconductor light source. In this way, the optical sensor may itself process the light from the first semiconductor light source and the light from the second semiconductor light source to yield the desired sensor signals and “condense” the desired spectral information into meaningful controlled variables, without the need for complex solutions with spectrometers and digital software evaluation.

With different spectral dependencies of the sensitivity of the optical sensor, different feedback control tasks with regard to the temperature dependency of the mixed light, in particular the color location thereof, may be performed. In particular, it may be an objective of the optoelectronic device described here for the mixed light to exhibit the lowest possible temperature and/or current and/or ageing dependency with regard to its color location.

In this case, the second characteristic wavelength may for example lie in the region of the falling edge of the V_{λ} curve. This means that the second characteristic wavelength lies in a green to red wavelength range above approximately 550 nanometers. The first characteristic wavelength may lie for example in a blue to green wavelength range, such that the mixed light of the optoelectronic device may impart a white light appearance. In particular, the first characteristic wavelength may for example lie on the rising edge or the maximum of the V_{λ} curve in the range of between approximately 400 to 550 nanometers.

Because of the above explanations with regard to the spectral sensitivity of the human eye, it would be obvious, for the second characteristic wavelength in the region of the falling edge of the V_{λ} curve for the second sensitivity to exhibit the same wavelength-dependent gradient as the V_{λ} curve in the second wavelength range, since a person skilled in the art would intuitively suppose that the wavelength-dependent perception of the human eye could be compensated by such a sensitivity adapted to the V_{λ} curve. If here and hereinafter wavelength-dependent gradients of the V_{λ} curve and wavelength-dependent gradients of the first and second sensitivities are compared, it is assumed, unless explicitly stated otherwise, that the respective spectral dependencies are normalized to a maximum value of 1. In this case, the average wavelength-dependent gradient of the V_{λ} curve in the wavelength range of between 600 and 650 nanometers is approximately −1%/nm.

However, it has surprisingly emerged that with a second sensitivity, which exhibits a different wavelength-dependent gradient from the V₈₀ curve in the second wavelength range, improved feedback control of the color location of the mixed light is possible with regard to minimal temperature and ageing dependency. In particular, it has emerged that, if the second characteristic wavelength becomes greater as temperatures increase, it is particularly advantageous for the ratio of the average wavelength-dependent gradient of the second sensitivity to the average wavelength-dependent gradient of the V_{λ} curve in the second wavelength range to be less than 1. This means in other words that the second sensitivity decreases more slowly with the growing wavelength than does the V_{λ} curve. In particular, the ratio of the average wavelength-dependent gradient of the second sensitivity to the average wavelength-dependent gradient of the V_{λ} curve in the second wavelength range may be less than or equal to 0.8 and greater than or equal to 0.2 and particularly preferably approximately 0.5.

The optoelectronic device described herein may in particular be configured such that a mixed light may be emitted which, in a temperature range of greater than or equal to 0° C. and less than or equal to 60° C., preferably less than or equal to 100° C., and particularly preferably of greater than or equal to −40° C. and less than or equal to 125° C., exhibits a temperature-dependent color location shift around an average color location which extends along a main axis of a McAdams ellipse around the average color location. In this case, the color location shift and the average color location may be characterized by a first color location of the mixed light emitted at an optoelectronic device temperature of for example 0° C. and by a second color location of the mixed light emitted at a temperature of for example 60° or 100° C. The temperature-dependent color location shift may be characterized in a first approximation by the connecting line between the first and second color locations. “Along the main axis” means in this context that the geometric projection of this connecting line onto the main axis of the McAdams ellipse is longer than the projection of the connecting line onto the secondary axis of the same McAdams ellipse. Particularly preferably, the connecting line and thus also the color location shift of the mixed light extend parallel or at least approximately parallel to the main axis of the associated McAdams ellipse. Color location shifts, which extend from the centre point or reference color location along the main axis of a McAdams ellipse, are less readily perceptible than those which extend along the secondary axis of the McAdams ellipse with a numerically identical color coordinate difference.

The optoelectronic device may comprise a housing or a printed circuit board in which or on which are arranged the first semiconductor light source, the second semiconductor light source and the optical sensor. The housing may comprise a plastic, in particular a thermoplastic or a thermoset. For example, the housing may be produced by a molding process such as for instance transfer molding, injection molding, compression molding, cutting, sawing, milling or a combination thereof. The plastic may in this case comprise siloxane and/or epoxy groups and for instance take the form of silicone, epoxy resin or a hybrid material of a mixture or a copolymer of silicone and epoxy. Alternatively or in addition, the plastic may also comprise polymethyl methacrylate (PMMA), polyacrylate, polycarbonate and/or imide groups. The housing may for example comprise a well, in which at least the first semiconductor light source and the second semiconductor light source is arranged and by means of which the light in the first wavelength range may be emitted. The optical sensor may likewise be arranged in the well.

The housing may additionally comprise a lead frame for electrical contacting of the first semiconductor light source, the second semiconductor light source and the optical sensor. The lead frame may in this case be integrated into the housing, wherein the lead frame is molded around or surrounded by the housing body, and/or encapsulated thereby. The lead frame may comprise one or more mounting regions, on which the first semiconductor light source, the second semiconductor light source and the optical sensor may be placed. The lead frame may in this case comprise a plurality of electrical connection options for electrical contacting of the first semiconductor light source, the second semiconductor light source and the optical sensor, which take the form of bond pads or mounting surfaces, for instance. The mounting region or the mounting regions may here in particular allow suitable interconnection and also electrical connection of the first semiconductor light source, the second semiconductor light source and optionally also of the optical sensor to an external current and voltage supply and/or to the feedback controller. The mounting region may for example take the form of a mounting surface on the lead frame. Arranging the first and second semiconductor light source and the optical sensor in a housing thus permits a compact and space-saving optoelectronic device.

Furthermore, the optoelectronic device may comprise a third semiconductor light source with at least one third light-emitting diode, which, when in operation, emits light with a third characteristic wavelength in a third wavelength range and with a third intensity on application of a third current. The third wavelength range may in this case be different from the first and second wavelength range. The third characteristic wavelength and the third intensity may exhibit a third temperature dependency and/or current dependency and/or ageing. In particular, a part of the light of the third semiconductor light source may be emitted onto the optical sensor which comprises a third wavelength-dependent sensitivity in the third wavelength range, which sensitivity is adapted to the third temperature dependency and/or current dependency and/or ageing of the third semiconductor light source. In particular, the feedback controller may control the first, second and third currents in such a way that in each case two of the first, second and third sensor signals exhibit a predetermined ratio.

The third semiconductor light source and the third LED may comprise one or more features or combinations thereof, as described further above in connection with the first and second semiconductor light source and the first and second LEDs. The third sensitivity of the optical sensor may be made possible by the intrinsic sensitivity of the sensor itself in the third wavelength range or indeed by a combination of the optical sensor with an optical filter as described above. In particular, the optical sensor may also comprise a third sensor facet and/or further above-stated features.

Further advantages and advantageous embodiments and further developments of the invention are revealed by the embodiments described below in conjunction with FIGS. 1A to 11B, in which:

FIG. 1A is a schematic representation of the V_{λ} curve,

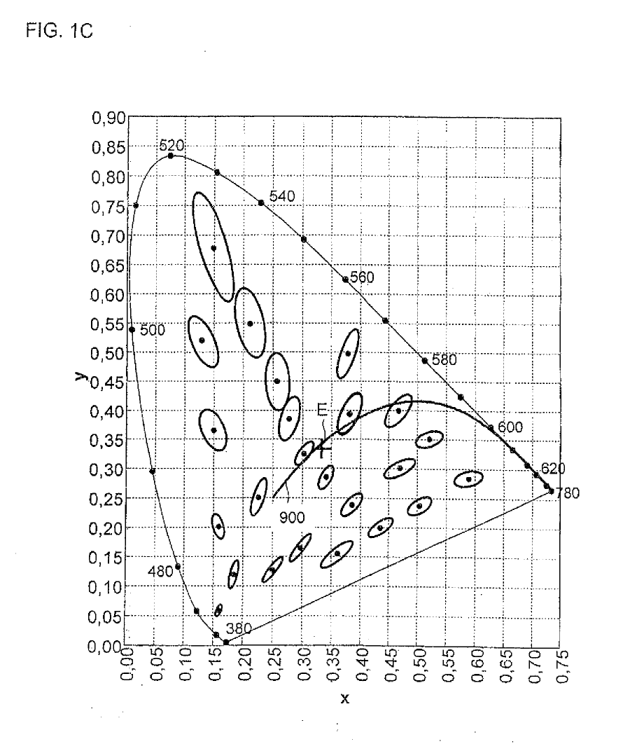

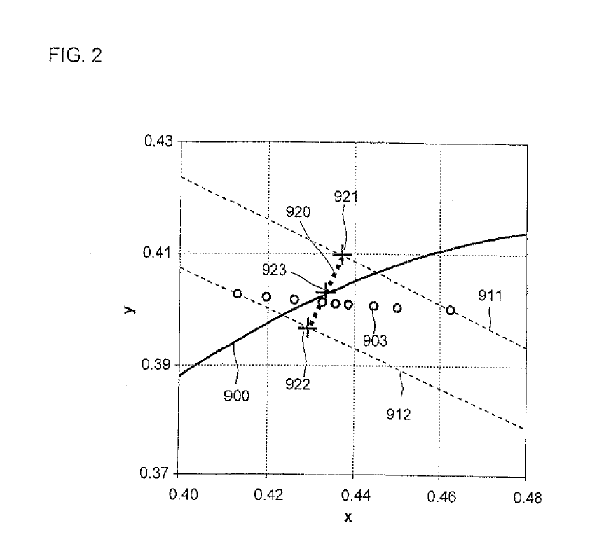

FIGS. 1B to 2 are schematic representations of the CIE standard chromaticity diagram,

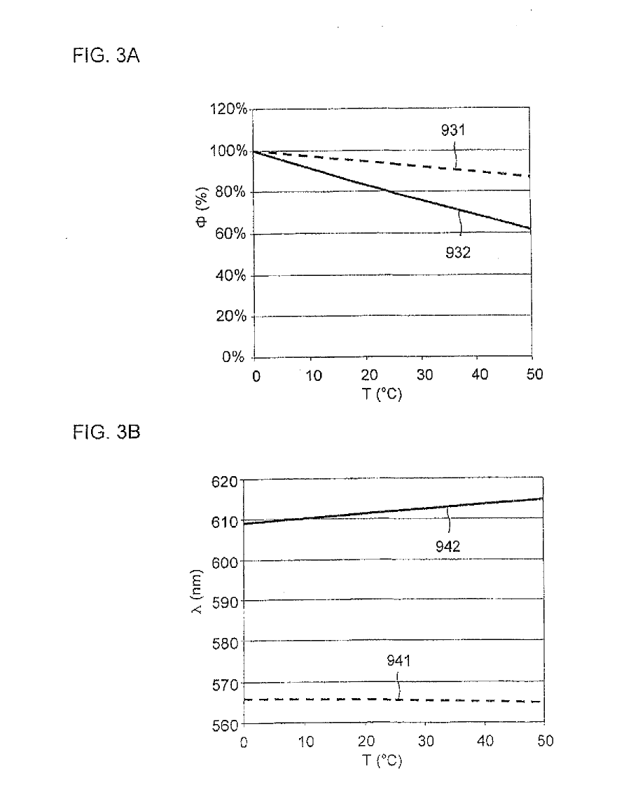

FIGS. 3A and 3B show graphs of temperature dependencies of first and second LEDs according to one exemplary embodiment,

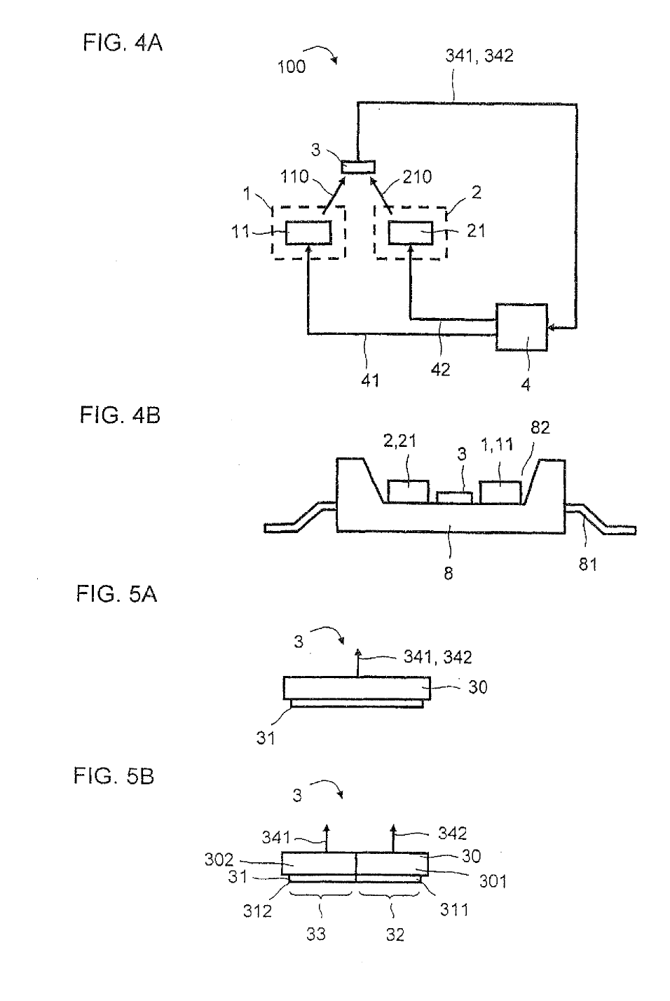

FIGS. 4A to 4E show schematic representations of an optoelectronic device according to a further exemplary embodiment,

FIGS. 5A and 5B are schematic representations of optical sensors according to further exemplary embodiments,

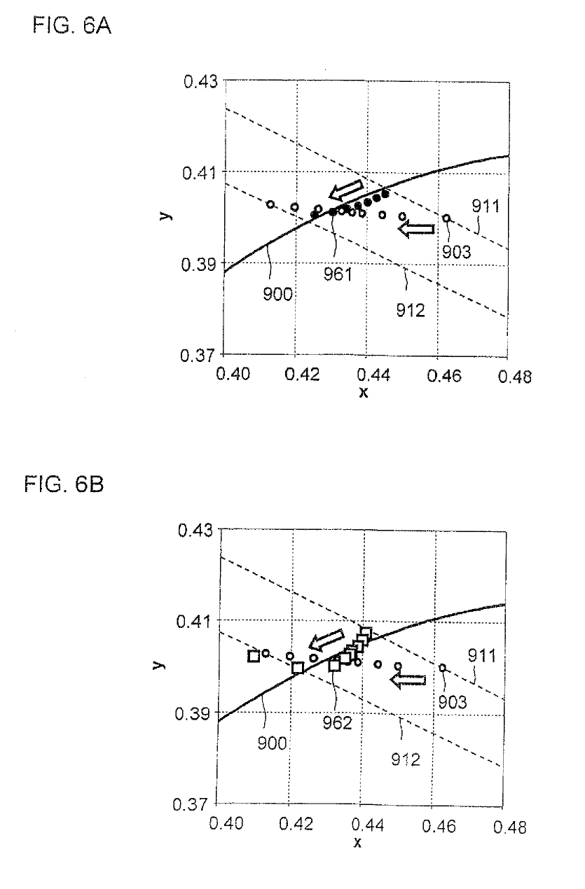

FIGS. 6A and 6B are schematic representations of color location shifts of optoelectronic devices,

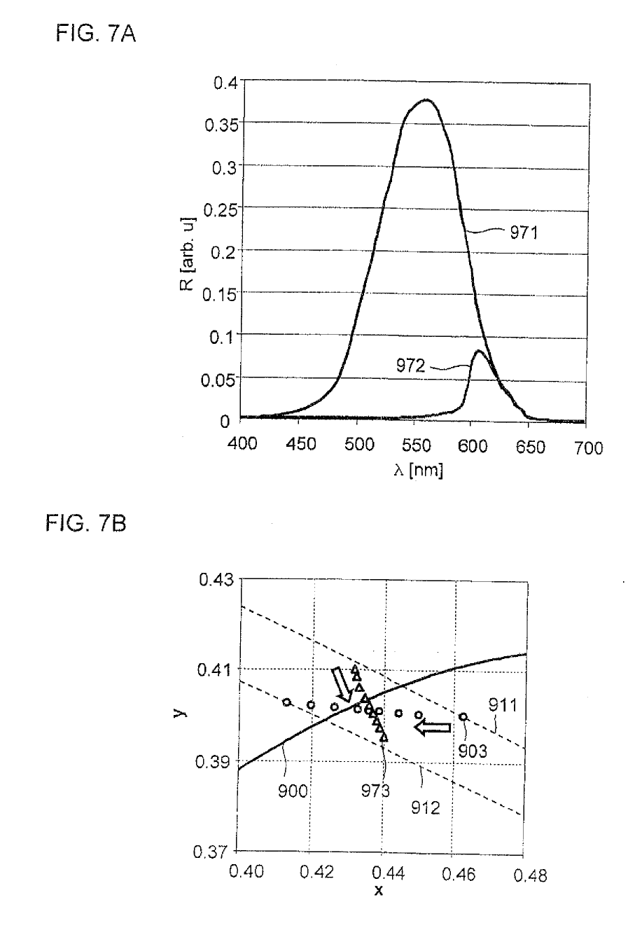

FIGS. 7A to 10B are schematic representations of sensitivities of optical sensors and the resultant temperature-dependent color location shifts of the mixed light of optoelectronic devices according to further exemplary embodiments and

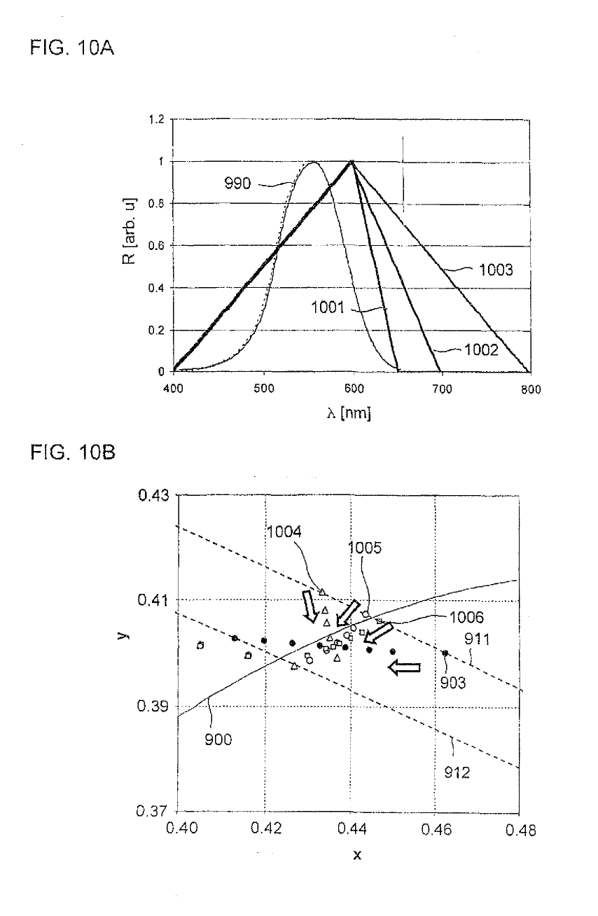

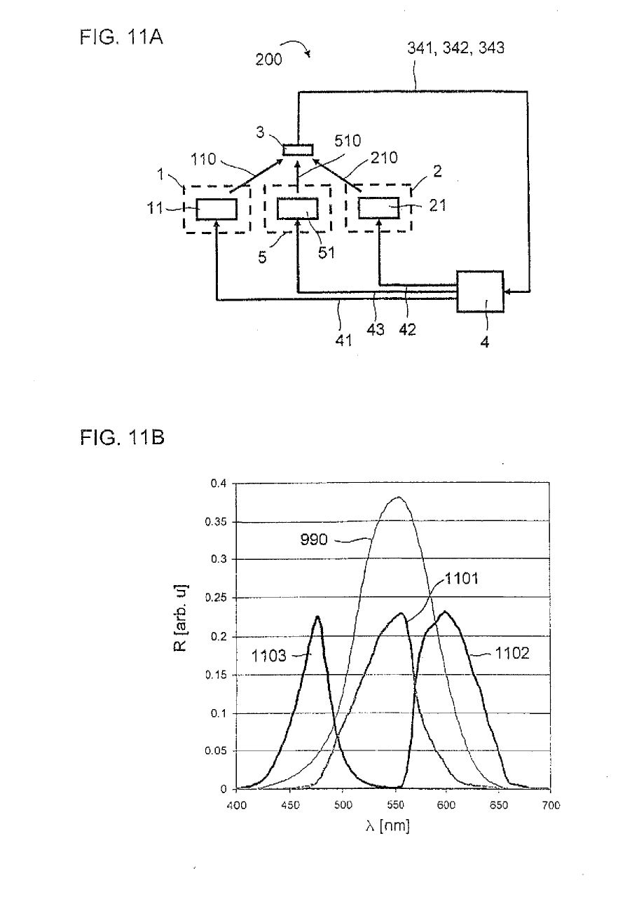

FIGS. 11A to 11B show schematic representations of an optoelectronic device and first, second and third sensitivities of an optical sensor according to a further exemplary embodiment.

In the exemplary embodiments and figures, identical or identically acting constituents may in each case be provided with the same reference numerals. The elements illustrated and their size ratios to one another should not in principle be regarded as being to scale, but rather individual elements, such as for example layers, components, structural elements and zones, may have been made exaggeratedly thick or large to illustrate them better and/or to make them easier to understand.

In FIG. 1A, as described in the introductory section, the “V_{λ} curve” 990 is shown for a wavelength range from 400 to 700 nanometers. The average spectral sensitivity R of the human eye is here plotted on the y axis in arbitrary units. If in the following exemplary embodiments wavelength-dependent gradients of the V_{λ} curve are indicated and/or compared with wavelength-dependent gradients of the first and second sensitivities, it is assumed, unless explicitly stated otherwise, that the respective spectral dependencies are normalized to a maximum value of 1. This means that statements relating to wavelength-dependent gradients of the V_{λ} curve are based on a V_{λ} curve normalized to 1, whose maximum at approximately 555 nanometers exhibits a spectral sensitivity R of 1. For the V_{λ} curve standardized in this way, the average wavelength-dependent gradient in the wavelength range of between 600 and 650 nanometers is approximately −1%/nm.

In the following exemplary embodiments first semiconductor light sources 1 are described with at least one first LED 11, which brings about a cold white to yellowish-green light appearance. The at least one first LED 11 to this end comprises, purely by way of example and as described in the general section, a blue emitting, InGaN-based epitaxial layer sequence, on which a yellow-green emitting wavelength conversion material is applied. The color location lies approximately with its x coordinate in the range from 0.36 to 0.37 and its y coordinate in the range from 0.42 to 0.44, and the characteristic first wavelength of the first LED 11 is approximately 565 nanometers. To generate warm white mixed light emitted by an optoelectronic device, the second semiconductor light sources 2 described below are provided with at least one second LED 21, which emits light in a second, orange-red to red wavelength range around a second characteristic wavelength of approximately 610 nanometers. To generate warm white mixed light by means of LEDs, conventionally red wavelength conversion materials are also used in conjunction with a blue emitting epitaxial layer sequence. However, due to the typically wide emission bands of red emitting wavelength conversion materials, a lot of power may lie in a wavelength range in which eye sensitivity is very low, i.e., as is clear from the V_{λ} curve 990 in FIG. 1A, in the region of greater than or equal to approximately 640 nanometers. Preferably, therefore, no additional red emitting wavelength conversion material is used for the exemplary embodiments of optoelectronic devices described below. Instead, the light with the second wavelength range is generated by the material of the epitaxial layer sequence of the at least one second, InGaAlP-based LED 21 without using an additional red emitting wavelength conversion material.

By using second semiconductor light sources 2 and second LEDs 21, which are directly capable of generating red light, the second wavelength range may be better selected in the readily perceptible red wavelength range below 640 nanometers. In this way, a high efficiency of more than 100 lumen/watt may be achieved for the optoelectronic devices described below with a simultaneously high color rendering value of more than 90 by combinations of the illustrated white emitting first semiconductor light sources 1 and red emitting second semiconductor light sources 2.

As an alternative to the combinations described here purely by way of example, with greenish yellow to white emitting first semiconductor light sources 1 and red emitting second semiconductor light sources 2, any other combination of first and second semiconductor light sources with emission spectra in other first and second wavelength ranges may however also be used, if a different color and light impression of the mixed light is desired. A feature common to all conceivable optoelectronic devices according to the present description is the principle described herein of feedback control and stabilization of the color location of the emitted mixed light generated by at least one first and one second semiconductor light source.

In particular, the exemplary embodiments described below may quite generally comprise at least one first and one second semiconductor light source for “multicolor systems”, which, to increase white light quality, allow good adjustability of the white point, for instance optoelectronic devices which emit a mixed light with at least one first and one second or indeed more wavelength ranges which in each case bring about a blue, white, orange-colored, red and/or deep red light and color appearance.

FIG. 1B shows a CIE standard chromaticity diagram known to a person skilled in the art, with the color coordinate x on the horizontal axis and the color coordinate y on the vertical axis. In this case, the line 900 denotes the “white curve” of a Planckian black body radiator at different temperatures thereof. These temperatures are also known as color temperatures. The cross E denotes the (mathematical) white point with the color coordinates x=y=0.33, which corresponds approximately to a color temperature of 5500 kelvin.

Furthermore, FIG. 1B indicates the color locations 901 for the above-described first LED 11 with an emission spectrum in the greenish-white first wavelength range for different ambient temperatures from 0° C. to 50° C. The arrow next to the color locations 901 indicates the color location change for rising ambient temperatures of between 0° C. and 50° C. For the above-described second LED 21 with the emission spectrum in the red second wavelength range, the color locations 902 are shown in the same temperature range from 0° C. to 50° C., wherein here too the color location change for rising ambient temperatures is indicated by the associated arrow.

In addition to FIG. 1B, FIG. 3A further shows in relative units the changes, accompanying the change in ambient temperature T in degrees Celsius, of the first intensity for the first LED 11 by means of the curve 931 and of the second intensity for the second LED 21 by means of the curve 932, wherein here in each case a constant operating current was assumed for the LEDs. The change in the first and second characteristic wavelengths λ of the first and second wavelength ranges is additionally shown in FIG. 3B in nanometers by curve 941 for the first LED 11 and by curve 942 for the second LED 21, as a function of the ambient temperature T in degrees Celsius.

It is clear from FIGS. 3A and 3B that the second characteristic wavelength of the second, red emitting LED 21 shifts towards longer wavelengths λ for rising ambient temperatures and the emitted light simultaneously loses around 40% of its intensity. In comparison, the first characteristic wavelength of the first LED 11 shifts towards somewhat shorter wavelengths, which is explained by the fact that the wavelength conversion material of the first LED 11 becomes less efficient at higher temperatures. In this way, less converted light may be emitted by the first LED, such that a more bluish color appearance arises because the proportion of converted light falls. At the same time, the emitted first intensity of the first LED 11 decreases by less than 20%. In the exemplary embodiment shown, the first LED 11 thus proves to be more temperature stable than the second LED 21 and to exhibit a lesser first temperature dependency of the first characteristic wavelength and the first intensity compared with the second temperature dependency of the second characteristic wavelength and the second intensity.

In the case of constant operating currents in accordance with a preselected ratio of the first current to the second current and non-feedback controlled superposition of the light emitted by the first LED 11 and the second LED 21 with the first and second temperature dependencies shown, a temperature dependency arises for the resultant mixed light with the color locations 903 in FIG. 1B in the region indicated by means of lines 911 and 912. It is apparent that the light appearance of the mixed light shifts towards higher color temperatures or CCT in the event of an increase in the ambient temperature from 0° C. to an ambient temperature of 50° C.

Additionally occurring ageing effects of the first and second LEDs 11, 21, which have not yet been taken into account, may likewise result in changes to the respectively emitted intensity and the respective characteristic wavelength and the respective wavelength range. In particular, the “initial ageing” should also be taken into consideration here, as this may cause severe fluctuations in the color location of the mixed light for various chip types. It should moreover be pointed out that the color locations 903 of the non-feedback controlled mixed light may be shifted by a change in the preselected ratio of the first current to the second current in the region indicated by lines 911 and 912.

FIG. 2 shows a portion of the CIE standard chromaticity diagram of FIG. 1B in the region where the color coordinate x has a value between 0.40 and 0.48 and the color coordinate y has a value between 0.37 and 0.43, in which portion the temperature dependency of the color locations 903 of the non-feedback controlled mixed light is more clearly apparent. Taking this as basis, the following exemplary embodiments are based on the consideration that feedback control of the ratio of the first intensity of the first LED 11 relative to the second intensity of the second LED 21, identical temperatures being assumed here and hereinafter for all the LEDs, does not enable feedback control to a single color location 903 because of the respective temperature dependencies of the first and second characteristic wavelengths. However, on condition that the first and second semiconductor light sources 1, 2 are subject to the same temperature fluctuations and particularly preferably exhibit the same operating temperatures, it is possible with the optoelectronic devices described below to minimize the temperature dependency of the color locations 903 if feedback control brings about for example a color location shift along the connecting line 920 between the color location 921 at an ambient temperature of 0° C. and the color location 922 at an ambient temperature of 50° C. In this case the connecting line 920 is selected such that it lies perpendicular to the lines 911 and 921 and therefore purely mathematically means a minimal color location shift. Furthermore, the connecting line 920 extends along the main axis of the McAdams ellipse, which lies around the centre point 923 of the connecting line 920. A number of MacAdams ellipses, magnified around ten times, are indicated in the CIE standard chromaticity diagram in FIG. 1C for clarification purposes. By feedback control along the main axis of a McAdams ellipse it is possible, as explained in the general section, to further minimize the perceptibility of the color location change of the color locations 903 of the mixed light. The connecting line 920 illustrated in FIG. 2 is shown purely by way of example. As an alternative, other connecting lines between a first point on the line 911 and a second point on the line 912 are conceivable, to achieve desired color location dependencies of the mixed light by appropriate feedback control and compensation of the temperature-dependent change of the first and second intensities.

In order to achieve such a desired feedback control of the mixed light of an optoelectronic device with the above-described first and second semiconductor light sources, the simplest possible embodiment is thus sought which takes account of both the temperature dependencies of the LEDs 11, 21 according to FIGS. 3A and 3B and the wavelength-dependent spectral sensitivity of the human eye according to the V_{λ} curve of FIG. 1A.

To this end, FIG. 4A is a schematic representation of an optoelectronic device 100 according to one exemplary embodiment which comprises a first semiconductor light source 1 with an above-described first LED 11 and a second semiconductor light source 2 with an above-described second LED 21. Purely by way of example, in the exemplary embodiment shown the first and second semiconductor light sources 1, 2 in each case have precisely one first or precisely one second LED 11, 21. As an alternative, the first and/or second semiconductor light sources 1, 2 may also comprise a plurality of first or second LEDs 11, 21. When operating the optoelectronic device 100, a first current 41 is applied to the first semiconductor light source 1 and a second current 42 is applied to the second semiconductor light source 2.

The optoelectronic device 100 further comprises an optical sensor 3, onto which is directed a part 110 of the light emitted by the first semiconductor light source 1 and a part 210 of the light emitted by the second semiconductor light source 2. In the first wavelength range the optical sensor 3 exhibits a first wavelength-dependent sensitivity and in the second wavelength range a second wavelength-dependent sensitivity. The parts 110, 210 of the light of the first or second semiconductor light sources 1, 2 are converted by the optical sensor 3 into a first and a second sensor signal 341, 342. The respective signal strength depends, due to the first and second wavelength-dependent sensitivities, on the wavelength ranges or the characteristic wavelengths and on the intensities of the parts 110, 210 of the light emitted by the semiconductor light sources 1, 2. By initially fixing the ratio of the first current 41 to the second current 42 or by selecting the ratio of the first sensor signal 341 to the second sensor signal 342, the average color location of the mixed light may be established under preselected operating conditions. The average color location may additionally also be preselected by a suitable number of first LEDs 11 in the first semiconductor light source 1 and/or by a suitable number of second LEDs 21 in the second semiconductor light source 2.

Furthermore, the optoelectronic device 100 comprises a feedback controller 4, which controls the first and second currents 41, 42 in such a way that the first sensor signal 341 and the second sensor signal 342 exhibit a predetermined ratio, which for example remains constant. To this end, the feedback controller 4 comprises analogue and/or digital passive and active electronic components and circuits, which may for example also take the form of one or more integrated circuits. Such feedback control circuits, which operate for example according to the principles of proportional controllers (P controllers), for example also with additional integral control (PI controller) and/or differential control (PD control, PID control), are known to a person skilled in the art and will not be explained any further here. In the exemplary embodiment shown, the feedback controller 4 may in particular also take the form of current drivers for the first and second semiconductor light sources 1, 2, providing the first and second currents 41, 42 directly for the first and second semiconductor light sources 1, 2.

FIG. 4B shows part of the optoelectronic device according to the previous exemplary embodiment. The first semiconductor light source 1, the second semiconductor light source 2 and the optical sensor 3 are here arranged in a housing 8 which purely by way of example takes the form of a surface-mountable housing. The housing 8 comprises a plastic, for instance epoxy and/or silicone, and may be produced for example by means of a molding process, as described in the general section. Furthermore, the housing 8 comprises a lead frame 81 for electrical connection or contacting of the first and second semiconductor light source 1, 2 and the optical sensor 3. The lead frame 81 is molded around by the plastics material of the housing 8 and exhibits a suitable connection topography for allowing contacting of the components arranged in the housing 8 (not shown).

The first and second semiconductor light sources 1, 2 and the optical sensor 3 are arranged in a well 82 in the housing 8. A transparent plastics potting compound (not shown) may additionally be arranged in the well 82 to protect the semiconductor light sources 1, 2 and the optical sensor 3. As an alternative the semiconductor light sources 1, 2 and the optical sensor 3 may also be mounted on the lead frame 81 and then molded around with the plastics material of the housing 8, wherein the housing 8 may then also be transparent and lack the well 82. The parts 110, 210 indicated in FIG. 4A of the light directed by the first and second semiconductor light sources 1, 2 onto the optical sensor 3 may, in the arrangement shown, each comprise a part of the light emitted sideways, i.e. parallel to the mounting plane, by the first and second LEDs 11, 21.

In the exemplary embodiment shown, the first and second semiconductor light sources 1 and 2 are in thermal contact through the housing 8 and the lead frame 81. The housing 8 and in particular the lead frame 81 here act as heat sinks, which allow uniform temperature distribution of the semiconductor light sources 1 and 2. This makes it possible to minimize self-heating effects in the semiconductor light sources 1 and 2 and to expose the semiconductor light sources 1 and 2 as far as possible to the same temperatures and temperature changes, so as to enable reproducible behavior of the optoelectronic device 100.

The arrangement of the first and second semiconductor light sources 1, 2 and the optical sensor 3 in the housing 8 produces an extremely compact structure. The feedback controller 4 may be arranged in a further housing or indeed in the form of an integrated circuit in the housing 8. To this end, the feedback controller 4 may for example also be molded around with the housing material, together with the lead frame 8.

In the exemplary embodiment shown, the optical sensor 3 of the optoelectronic device 100 according to FIG. 4A or according to FIG. 45 comprises a silicon photodiode 30, as shown in detail in FIGS. 5A and 5B in two exemplary embodiments, electrical connections, for example, not being shown for the sake of clarity. In accordance with the above explanations, the first and second sensitivities of the optical sensor 3 are adapted to the first and second temperature dependencies of the first or second semiconductor light sources 1, 2 respectively. This may be achieved by suitable selection of the sensor material of the photodiode 30 itself. In the exemplary embodiment shown, however, a standard photodiode 30 with an active area of at least 300 micrometers by 300 micrometers is used, as may be obtained from Hamamatsu Photonics K.K. for instance and whose intrinsic sensitivity in the first and second wavelength ranges of the semiconductor light sources 1, 2 is not adapted to the first and second temperature dependencies of the first or second semiconductor light sources 1, 2 respectively.

Therefore, in the exemplary embodiment according to FIG. 5A the optical sensor 3 comprises an optical filter 31 over the active light-sensitive area, which filter exhibits a transmittance for light in the first and second wavelength ranges which, together with the intrinsic sensitivity of the photodiode 30, results in the desired first and second wavelength-dependent sensitivities. The parts 110, 210 of the light directed by the first or second semiconductor light source 1, 2 onto a large area of the optical sensor 3 are converted by the photodiode 30 into an electrical signal. In order to obtain the first and second sensor signals 341, 342 from the electrical signal, the first and second currents 41, 42 are amplitude-modulated with two different frequencies by switching the currents on and off. The feedback controller 4 comprises frequency mixing and filter circuits suitable for demodulation, which are known to a person skilled in the art and are not explained any further here.

Alternatively or in addition, it is possible, as shown in FIG. 5B, for the optical sensor 3 also to comprise a first sensor facet 32 and a Second sensor facet 33, which are optically and electrically separated from one another. Electrical separation may for example be effected by a photodiode array or a patterned photodiode 30 with mutually separate active regions 301 and 302. Optical separation is effected, in the exemplary embodiment shown, by an optical filter 31, which comprises a light-transmitting region 311 in the first wavelength range and a light-transmitting region 312 in the second wavelength range. In this way, the part 110 of the light with the first wavelength range and the part 210 of the light with the second wavelength range may be discriminated from one another by the optical filter 31 and the first and second sensor facets 32, 33 may provide the first and second sensor signals 341, 342 separately from one another.

The following figures show the feedback control behavior of the optoelectronic device 100 for various examples and exemplary embodiments of optical sensors 3 with various first and second wavelength-dependent sensitivities. In this case, the temperature-dependent color location changes of the mixed light emitted by the optoelectronic device 100 were investigated as a function of ambient temperature, wherein the temperature-dependent color location change 903 of the non-feedback controlled superposition of the light of the first and second semiconductor light sources 1, 2, explained in conjunction with FIGS. 1B to 3B, is also shown for comparison purposes in the following portions of the CIE standard chromaticity diagram. In particular, the arrows indicate the color location shifts shown in each case in the event of an increase in ambient temperature from 0° C. to 60° C. in a number of 5° C. and 10° C. steps.

FIGS. 6A and 6B show the feedback control behavior of the optoelectronic device using optical sensors 3, which each take the form of commercially obtainable silicon photodiodes (obtainable for example from Hamamatsu Photonics K.K.). FIG. 6A shows the feedback control behavior in the form the color location change 961 when using a broadband photodiode, which exhibits an intrinsic sensitivity increasing continuously from approximately 300 nanometers to approximately 1000 nanometers, which then falls away again quickly for wavelengths of over approximately 1000 nanometers to approximately 1100 nanometers. FIG. 6B on the other hand shows the feedback control behavior in the form of the color location change 962 when using a “VIS photodiode”, which exhibits a sensitivity maximum at approximately 550 nanometers, which falls away quickly on the shortwave side to approximately 300 nanometers and on the longwave side to approximately 800 nanometers.

Both feedback control behaviors exhibit color location shifts 961, 962, which substantially extend along the white curve 900. In comparison to the non-feedback controlled variant shown by means of the color locations 903, the color location shift is indeed partially compensated, but not sufficiently, since above all the falling eye sensitivity in the red, second wavelength range (see also FIG. 1A) is not taken into account and the first characteristic wavelength of the first semiconductor light source 1 shifts to shorter wavelengths when the temperature rises, while the second characteristic wavelength of the second semiconductor light source 2 shifts to longer wavelengths as described above when the temperature rises. The use of conventional silicon photodiodes with the above-described intrinsic sensitivity thus results in inadequate feedback control behavior.

With curve 971, FIG. 7A shows the sensitivity for an optical sensor 3 according to FIG. 5A, which takes the form of an “ambient light detector” (ALD) and simulates the wavelength-dependent sensitivity of the human eye. The sensitivity or sensitivity curve 971 thus corresponds to the V_{λ} curve 990 of FIG. 1A. To this end, the optical sensor 3 comprises a suitable optical filter 31, which, in combination with the intrinsic sensitivity of the silicon photodiode 30, exhibits the sensitivity 971 shown in FIG. 7A. The sensitivity curve 972 shows the corresponding sensitivity of the second sensor facet 33 of an alternative optical sensor 3 according to FIG. 5B using an optical filter 31 with a suitable region 312.

As already shown in FIGS. 6A and 6B, FIG. 7B shows the feedback control behavior of the optoelectronic device in the form of the color location shift 973 using such optical sensors 3. As a result of the sensitivity 971 or 972 of the optical sensor, a feedback control behavior may thus be achieved which differs markedly from that shown in FIGS. 6A and 6B and allows temperature-dependent feedback control of the mixed light virtually perpendicularly to the white curve 900.

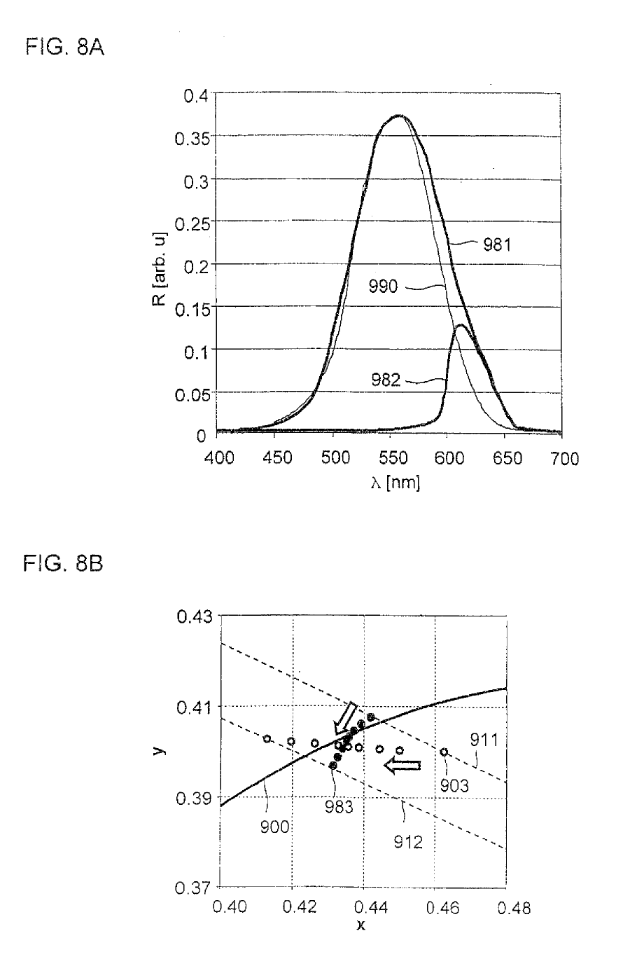

As far as the above explanations in relation to FIG. 2 are concerned, in this exemplary embodiment it is clear that the temperature-dependent color location shift of the mixed light emitted by the optoelectronic device is overcompensated. To achieve feedback control behavior of the optoelectronic device 100 with a minimally perceptible temperature-dependent color location shift of the mixed light emitted by the optoelectronic device, the sensitivity of a suitable optical sensor 3 is shown in FIG. 8A. FIG. 8A shows a modified sensitivity or sensitivity curve 981, compared to the V_{λ} curve 990, of an optical sensor 3 in the form of an ALD detector. This exhibits a second sensitivity in the region of the red, second wavelength range of the second semiconductor light source 2 with a wavelength-dependent gradient which is different from the wavelength-dependent gradient of the V_{λ} curve 990 in the second wavelength range. In particular, the sensitivity curve 981 falls more slowly on the longwave side than the V_{λ}. curve 990, such that the ratio of the average wavelength-dependent gradient of the second sensitivity to the average wavelength-dependent gradient of the V₈₀ curve 990 in the second wavelength range of approximately 600 to 650 nanometers is less than 1. The sensitivity curve 982 in turn shows the second sensitivity of a second sensor facet 33 for an optical sensor 3 according to FIG. 5B. FIG. 8B shows the feedback control behavior of the optoelectronic device 100 in the form of the temperature-dependent change in the color locations 983 of the emitted mixed light using such optical sensors 3. The color locations 983 in this case exhibit an average color location for an average temperature and, for varying temperatures, lie along the main axis of the McAdams ellipse associated with the average color location. With regard to the explanations given in conjunction with FIG. 2, it is clear that simple feedback control of the first and second semiconductor light sources 1, 2 is possible by means of an optical sensor 3, in which the first and second sensitivities are adapted to the temperature behavior of the first and second semiconductor light sources 1, 2, such that the desired minimal temperature-dependent color location shift of the mixed light emitted by the optoelectronic device is achieved.

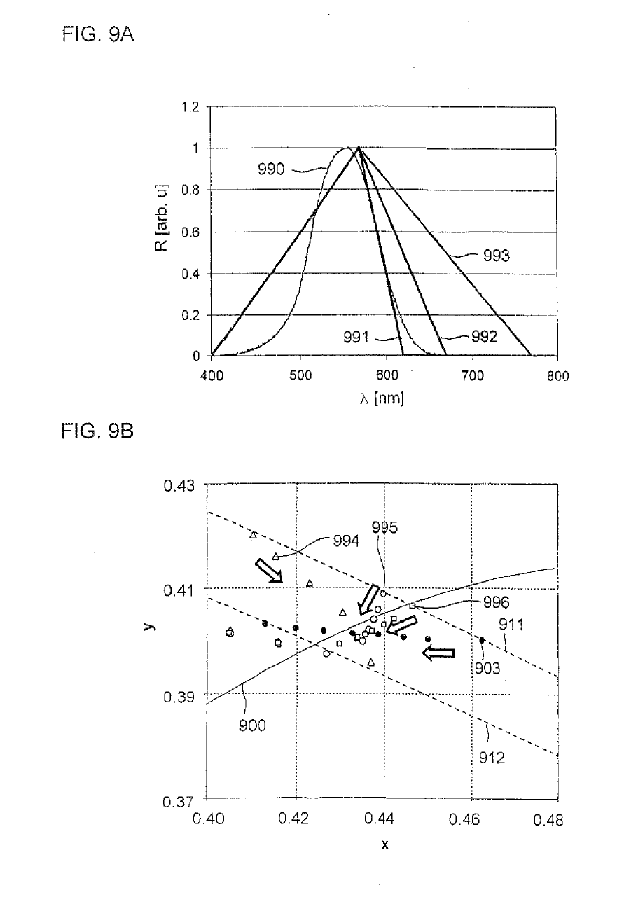

FIGS. 9A to 10B are simulations of the feedback control behavior of optoelectronic devices 100 in the form of temperature-dependent color location shifts of the emitted mixed light, wherein the optoelectronic devices 100 comprise optical sensors 3 with different first and second sensitivities. In this case, in comparison with the previous exemplary embodiments the sensitivities 991, 992, 993, 1001, 1002, 1003 shown of the optical sensor 3 were assumed purely by way of example to be triangle functions, which are in each case normalized to 1 like the V_{λ} curve 990 also shown.

The wavelength-dependent sensitivities 991, 992 and 993 in FIG. 9A exhibit a maximum sensitivity of 1 at 570 nanometers, while the wavelength-dependent sensitivities 1001, 1002 and 1003 in FIG. 10A exhibit a maximum sensitivity of 1 at 600 nanometers. With all the sensitivities or sensitivity curves shown, the sensitivity of the associated simulated optical sensor 3 increases in linear manner from 400 nanometers to the maximum. On the basis of a wavelength-dependent V_{λ} curve gradient of −2%/nm for a wavelength of 600 nanometers, the sensitivities 991, 992 and 993 in FIG. 9A or the sensitivities 1001, 1002 and 1003 in FIG. 10A exhibit the gradients −2%/nm, −1%/nm and −0.5%/nm. Here and hereinafter, the gradients are in this case defined as a percentage normalized to the maximum value. The above-stated gradients thus also correspond to the respective wavelength-dependent gradient of the second wavelength-dependent sensitivity of the optical sensor 3 in the second wavelength range. The color location shifts, resulting from the sensitivities shown, of the mixed light emitted by the simulated optoelectronic devices is shown in FIGS. 9B and 10B, wherein in FIG. 9B the sensitivity 991 underlies the color locations 994 (triangles), the sensitivity 992 underlies the color locations 995 (empty circles) and the sensitivity 993 underlies the color locations 996. (squares). In FIG. 10B the sensitivity 1001 underlies the color locations 1004 (triangles), the sensitivity 1002 underlies the color locations 1005 (empty circles) and the sensitivity 1003 underlies the color locations 1006 (squares). The color location “outliers” shown in FIGS. 9B and 10B at elevated temperatures, which lie outside the region indicated by the lines 911 and 912, are artefacts of the underlying simulation, which are due to the fact that during simulation only the second current was readjusted up to the assumed maximum value by the feedback controller 4 for feedback control of a constant ratio of the first and second sensor signals 341, 342.

With regard to a desired minimum temperature-dependent color location shift of the mixed light emitted by the optoelectronic device, it is clear from the two FIGS. 9B and 10B that with a wavelength-dependent gradient of the second sensitivity of −0.5%/nm (color locations 996 and 1006) and of −2%/nm (color locations 994 and 1004) under- or overcompensation takes place, wherein the overcompensation corresponds substantially to the feedback control behavior shown in FIGS. 7A and 7B in the case of first and second sensitivities according to the V_{λ} curve. In contrast, the temperature-dependent color location shifts of the color locations 995 in FIG. 9B and the color locations 1005 in FIG. 10B correspond most probably to the desired color location shift 920 described in FIG. 2 along the main axis of the associated McAdams ellipse. The shift of the sensor sensitivity into the red, i.e. the shift of the sensitivity maximum from 570 nanometers in FIG. 9A to 600 nanometers in FIG. 10, gives rise in principle to the same dependency, but the dependency of the quality of the feedback control on the wavelength-dependent gradient of the second sensitivity does fall somewhat. This may mean that a red-shifted edge results in more stable conditions, if for example the gradient of the spectral sensitivity and in particular the second sensitivity of the optical sensors is subject, due to its manufacture, to certain fluctuations.

In comparison to an average wavelength-dependent gradient of −1%/nm of the V_{λ} curve normalized to 1 at 555 nanometers, there thus results for an optical sensor 3 optimized in accordance with the requirements of FIG. 2 in the wavelength range between 600 and 650 nanometers an average wavelength-dependent gradient of the second sensitivity of less than or equal to −0.8%/nm, i.e. 80% of the corresponding average gradient of the V_{λ} curve, and greater than or equal to −0.2%/nm, i.e. 20% the corresponding average gradient the V_{λ} curve, and particularly preferably of approximately −0.5%/nm, i.e. 50% of the corresponding average gradient of the V_{λ} curve. The spectral dependencies exhibited by the respective second sensitivities in the second wavelength range should likewise in each case be regarded as normalized to the maximum value of 1. Since the detailed profile below a wavelength of approximately 600 nanometers may have less of an influence on feedback control behavior, the spectra under consideration could also be normalizsed to 1 with regard to their value at a wavelength of 600 nanometers, wherein the stated gradients would then have to be multiplied by a factor of 2.5.

FIG. 11A shows an optoelectronic device 200 according to a further exemplary embodiment, which is a modification of the optoelectronic device 100 according to FIG. 4A. In comparison with the optoelectronic device 100, the optoelectronic device 200 additionally comprises a third semiconductor light source 5 with at least one third LED 51. When a third current 43 is applied, in the exemplary embodiment shown the at least one third LED 51 and thus the third semiconductor light source 5 emits light with a third characteristic wavelength in a third, blue wavelength range and with a third intensity. Because the third wavelength range is different from the first and second wavelength ranges, in the case of the optoelectronic device 200 the above-described temperature-dependent color location change of the mixed light emitted by the optoelectronic device may be feedback-controlled and stabilized to one color location.

The third characteristic wavelength and the third intensity exhibit a third temperature dependency and/or current dependency and/or ageing, to which a third sensitivity of the optoelectronic sensor 3 is adapted. Purely by way of example, the first, second and third sensitivities 1101, 1102 and 1103 of the optical sensor 3 are shown in FIG. 11B and, for comparison, the V_{λ} curve 990. The optical sensor 3 converts a part 510 of the light emitted by the third semiconductor light source 5 into a third sensor signal 343. The feedback controller 4 controls the first, second and third currents 41, 42, 43 in such a way that the ratio in each case of two of the first, second and third sensor signals 341, 342, 343 corresponds in each case to a predetermined ratio which is either constant or varies in a predetermined manner as a function of the first and/or second and/or third sensor signals 341, 342, 343.

The color location of the mixed light may be adjusted through selection of the ratios of in each case pairs of the first, second and third sensor signals to one another. In the case of the wavelength ranges and characteristic wavelengths described herein, the optoelectronic device 200 for example allows adjustment of the color location towards which feedback control is directed along the white curve of the CIE standard chromaticity diagram. Through targeted selection of the first, second and third sensitivities 1101, 1102, 1103 of the optical sensor 3, the first, second and third temperature dependencies of the semiconductor light sources 1, 2 and 5 may in turn be compensated, such that no temperature-dependent or ageing-dependent color location shift of the mixed light emitted by the optoelectronic device 200 is any longer perceptible.

It is clear from the described exemplary embodiments that suitable adaptation of the first and second or the first, second and third sensitivities of the optical sensor 3 of the optoelectronic devices 100 and 200 precisely allows suitable feedback control behavior to be achieved, in which a desired color location stability of the mixed light of the optoelectronic device 100 or 200 may be achieved by means of the sensor signals provided by the optical sensor 3 and feedback control to constant sensor signal ratios through feedback control of the first, second and optionally third currents. This is possible because, in the case of optoelectronic devices 100 and 200 described herein for feedback control, not only the intensity variations but also the wavelength variations of the light emitted by the semiconductor light sources are converted directly into suitable sensor signals.

In general terms, the color location stabilization problem may be reduced, in the case of varying spectral components of the sources, by adapted spectral sensitivities in the respective spectral range of the sources (e.g. by one or more sensor facets) to feedback control of the sensor signals ratios, for instance keeping them constant, by feedback control of the source currents.

The description made with reference to exemplary embodiments does not restrict the invention to these embodiments. Rather, the invention encompasses any novel feature and any combination of features, including in particular any combination of features in the claims, even if this feature or this combination is not itself explicitly indicated in the claims or exemplary embodiments.

1. An optoelectronic device for emitting mixed light with light in at least one first and one second wavelength range, comprising:
a first semiconductor light source with a first light-emitting diode, which, on application of a first current, emits light with a first characteristic wavelength in the first wavelength range and with a first intensity;
a second semiconductor light source with a second light-emitting diode, which, on application of a second current, emits light with a second characteristic wavelength in the second wavelength range and with a second intensity, the first and second wavelength ranges exhibiting mutually different, wavelength-dependent intensity distributions;
an optical sensor for converting a part of the light emitted by the first semiconductor light source into a first sensor signal and a part of the light emitted by the second semiconductor light source into a second sensor signal; and
a feedback controller for feedback control of the first and second currents as a function of the first and second sensor signals,
wherein
the first characteristic wavelength and the first intensity of the light emitted by the first semiconductor light source exhibit a first temperature dependency and/or current dependency and/or ageing,
the second characteristic wavelength and the second intensity of the light emitted by the second semiconductor light source exhibits a second temperature dependency and/or current dependency and/or ageing which is different from the first temperature dependency,
the optical sensor exhibits a first wavelength-dependent sensitivity in the first wavelength range and a second wavelength-dependent sensitivity in the second wavelength range, these being adapted to the first and second temperature dependencies and/or current dependencies and/or ageing, and
the feedback controller feedback controls the first and second currents in such a way that the first sensor signal exhibits a given ratio to the second sensor signal.

2. The optoelectronic device according to claim 1, wherein the optical sensor comprises a photoactive material with the first and/or second sensitivity and/or at least one optical filter, which comprises a wavelength-dependent transmittance for adjusting the first and/or second sensitivity.

3. The optoelectronic device according to claim 1, wherein the optical sensor comprises a first sensor facet, onto which the part of the light in the first wavelength range is directed, and a second sensor facet, onto which the part of the light in the second wavelength range is directed.

4. The optoelectronic device according to claim 3, wherein the first sensor facet and the second sensor facet are separated optically and electrically from one another.

5. The optoelectronic device according to claim 1, wherein the optical sensor comprises a silicon photodiode.

6. The optoelectronic device according to claim 1, wherein the first and/or the second current is/are modulated when in operation.

7. The optoelectronic device according to claim 6, wherein the first and/or second current is/are modulated by being switched on and off.

8. The optoelectronic device according to claim 1, wherein the characteristic second wavelength lies in the region of the falling edge of the V_{λ} curve, and wherein the second sensitivity exhibits a wavelength-dependent gradient, which is different from the wavelength-dependent gradient of the V_{λ} curve in the second wavelength range.

9. The optoelectronic device according to claim 8, wherein the second characteristic wavelength becomes greater for rising temperatures, and wherein the ratio of the average wavelength-dependent gradient of the second sensitivity to the average wavelength-dependent gradient of the V_{λ} curve in the second wavelength range is less than 1.

10. The optoelectronic device according to claim 9, wherein the ratio of the average wavelength-dependent gradient of the second sensitivity to the average wavelength-dependent gradient of the V_{λ} curve in the second wavelength range is greater than or equal to 0.2 and less than or equal to 0.8.

11. The optoelectronic device according to claim 8, wherein the characteristic first wavelength lies in the region of the rising edge or of the maximum of the V_{λ} curve.

12. The optoelectronic device according to claim 1,
wherein the optoelectronic device comprises a third semiconductor light source with at least one third light-emitting diode, which, when in operation, emits light with a third characteristic wavelength in a third wavelength range and with a third intensity on application of a third current,
wherein the third wavelength range exhibits a wavelength-dependent intensity distribution different from the first and second wavelength ranges, and
wherein the third characteristic wavelength and the third intensity exhibit a third temperature dependency and/or current dependency and/or ageing.

13. The optoelectronic device according to claim 12,
wherein the optical sensor exhibits a third wavelength-dependent sensitivity in the third wavelength range, which is adapted to the third temperature dependency and/or current dependency and/or ageing,
wherein the optical sensor converts a part of the light emitted by the third semiconductor light source into a third sensor signal, and
wherein the feedback controller controls the first, second and third currents in such a way that in each case two of the first, second and third sensor signals exhibit a predetermined ratio.

14. The optoelectronic device according to claim 1, wherein the optoelectronic device furthermore comprises a housing, in which are arranged the first and second semiconductor light sources and the optical sensor.

15. An The optoelectronic device according to claim 1, wherein the mixed light in a temperature range of greater than or equal to 0° C. and less than or equal to 60° C. exhibits a temperature-dependent color location shift around an average color location which extends along a main axis of a McAdams ellipse around the average color location.
